(19) United States
(12) Patent Application Publication
(10) Pub. No.: US 2017/0250504 A1
(43) Pub. Date: Aug. 31, 2017

(54) JOINT CONNECTOR

(71) Applicants: HYUNDAI MOTOR COMPANY, Seoul (KR); KIA MOTORS CORPORATION, Seoul (KR); KUM CO., LTD., Ulsan (KR)

(72) Inventors: Min Jae BANG, Hwaseong-si (KR); In Sic KIM, Suwon-si (KR); Sung Won JEON, Ulsan (KR); Sang Ho BAE, Ulsan (KR); Ju Seong JEON, Ulsan (KR)

(21) Appl. No.: 15/221,898

(22) Filed: Jul. 28, 2016

(30) Foreign Application Priority Data
Feb. 25, 2016 (KR) 10-2016-0022256

(51) Int. Cl. H01R 13/631; H01R 13/502; H01R 13/518; H01R 13/26

(52) U.S. Cl. CPC H01R 13/631; H01R 13/26; H01R 13/502; H01R 13/518

(57) ABSTRACT

A joint connector includes a housing having a bus bar formed therein, having a plurality of accommodating holes in which a plurality of terminals connected to the bus bar are individually accommodated, and having insertion openings in communication with the plurality of accommodating holes, and a cover coupled to an outer surface of the housing and having a holder insertedly coupled to the insertion openings.

### CROSS-REFERENCE TO RELATED APPLICATION

This application claims the benefit of priority to Korean Patent Application No. 10-2016-0022256, filed on Feb. 25, 2016 with the Korean Intellectual Property Office, the disclosure of which is incorporated herein in its entirety by reference.

### TECHNICAL FIELD

The present disclosure relates to a joint connector, and more particularly, to a joint connector capable of effectively easing an assembly as well as reducing a cost of manufacturing the same by reducing a number of components.

### BACKGROUND

As is well known, a vehicle includes a variety of electrical and electronic components, and these components may be configured to be electrically connected to a power source of the vehicle through a joint connector.

The joint connector may perform a function of splitting a current from any one circuit to a plurality of circuits, or incorporating the current from the plurality of circuits to any one circuit.

The joint connector according to the related art may include an inside housing having a bus bar installed therein, a holder for locking a plurality of terminals connected to the bus bar of the inside housing, and an outside housing coupled to an outer surface of the inside housing.

Since the holder may be coupled to one side of the inside housing after the plurality of terminals is inserted into the inside housing, the plurality of terminals may be connected to the bus bar of the inside housing. Thereafter, since the outside housing may be coupled to the outer surface of the inside housing, the bus bar of the inside housing and the plurality of terminals may be electrically connected.

However, since the joint connector according to the related art may include a plurality of components, there may be a disadvantage that the number of assembly processes is increased to thereby cause a unit cost for manufacturing the same to be increased.

Further, the joint connector according to the related art may have disadvantages that connection structures between the bus bar and the terminals may be complex and that the terminals may not be firmly locked to the inside housing.

### SUMMARY

The present disclosure has been made to solve the above-mentioned problems occurring in the prior art while advantages achieved by the prior art are maintained intact.

An aspect of the present disclosure provides a joint connector capable of reducing a unit cost for manufacturing the same as well as reducing a number of assembly processes by minimizing the number of components, and also stably maintaining electrical connection performance by firmly locking terminals.

According to an exemplary embodiment of the present disclosure, a joint connector includes a housing having a bus bar formed therein, having a plurality of accommodating holes in which a plurality of terminals connected to the bus bar are individually accommodated, and having insertion openings which are in communication with the plurality of accommodating holes; and a cover coupled to an outer surface of the housing and to have a holder insertedly coupled to the insertion openings.

The bus bar may have a plurality of connection protrusions, the plurality of connection protrusions may be individually accommodated in the plurality of accommodating holes, and the terminal may be connected to each of the connection protrusions of the bus bar in each of the accommodating holes.

A connection part may be formed at a front end of the terminal, and the connection part may contact with a connection protrusion of the bus bar by an elastic force.

The holder may have a plurality of through openings through which each of the plurality of terminals individually passes.

According to another exemplary embodiment of the present disclosure, a joint connector includes a housing having a bus bar coupled to an interior thereof and accommodating a plurality of terminals connected to the bus bar; a cover coupled to the housing; and a locking part for locking the terminals to accommodating holes.

The locking part may include locking openings formed in the terminals, and locking protrusions protruding from inner surfaces of the accommodating holes to be insertedly coupled to the locking openings.

The housing may have a plurality of accommodating holes in which the plurality of terminals are individually accommodated, and insertion openings which are in communication with the plurality of accommodating holes, and the plurality of accommodating holes and the insertion openings may be formed to be perpendicular to each other.

The cover may include a holder insertedly coupled to the insertion openings of the housing, and the holder may have a plurality of through openings through which the plurality of terminals individually passes.

The terminal may have a stopper which catches on one surface of the holder.

### BRIEF DESCRIPTION OF THE DRAWINGS

The above and other objects, features and advantages of the present disclosure will be more apparent from the following detailed description taken in conjunction with the accompanying drawings.

FIG. 1 is an exploded perspective view illustrating a state in which a joint connector is exploded according to an exemplary embodiment of the present disclosure.

FIG. 2 is a view illustrating a process of coupling a bus bar to a housing in the joint connector according to an embodiment of the present disclosure.

FIG. 3 is a view illustrating a process of coupling a cover to a housing in a joint connector according to an embodiment of the present disclosure.

FIG. 4 is a coupled perspective view illustrating a state in which a housing is covered in a joint connector according to an embodiment of the present disclosure.

FIG. 5 is a view illustrating a process of coupling a plurality of terminals to a housing in a joint connector according to an embodiment of the present disclosure.

FIG. 6 is a coupled perspective view illustrating a state in which a joint connector according to an embodiment of the present disclosure is assembled.

FIG. 7 is a view illustrating a process of inserting terminals into accommodating holes of a housing of a joint connector according to an embodiment of the present disclosure.

FIG. 8 is a partial cut away perspective view illustrating a state in which terminals are locked to accommodating holes of a housing of a joint connector according to the present disclosure.

FIG. 9 is an enlarged view of part A of FIG. 8.

FIG. 10 is an enlarged view of part B of FIG. 8.

### DETAILED DESCRIPTION

Hereinafter, exemplary embodiments of the present disclosure will be described in detail with reference to the accompanying drawings. For reference, sizes of components, thicknesses of lines, and the like which are shown in the drawings referenced for describing the present disclosure may be slightly exaggerated for convenience of understanding. Further, since the terminologies used to describe the present disclosure are defined in consideration of the functions described in the present disclosure, they may be construed in different ways depending on a user, an intention of an operator, practices, and the like. Therefore, the definition of the terminologies should be construed based on the contents throughout the specification.

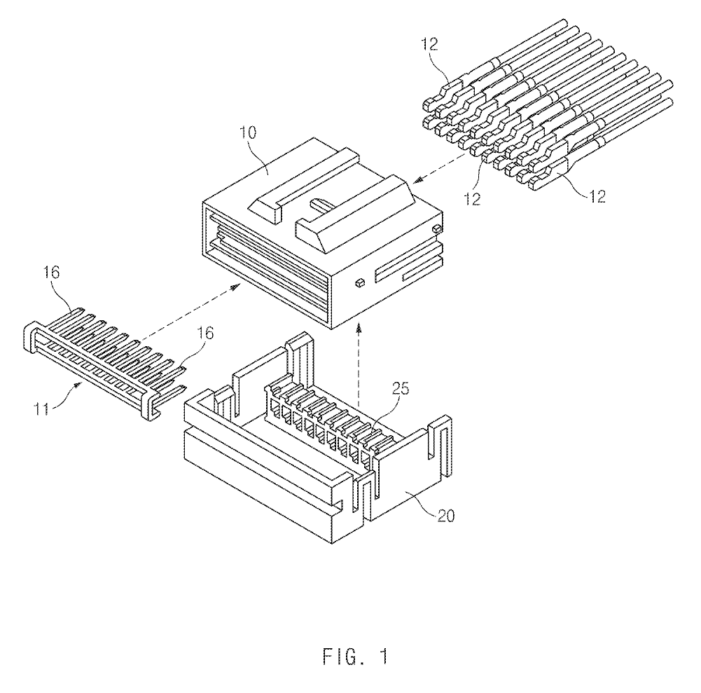

Referring to FIG. 1, a joint connector according to various exemplary embodiments of the present disclosure may include a housing 10 and a cover 20 separably coupled to the housing 10.

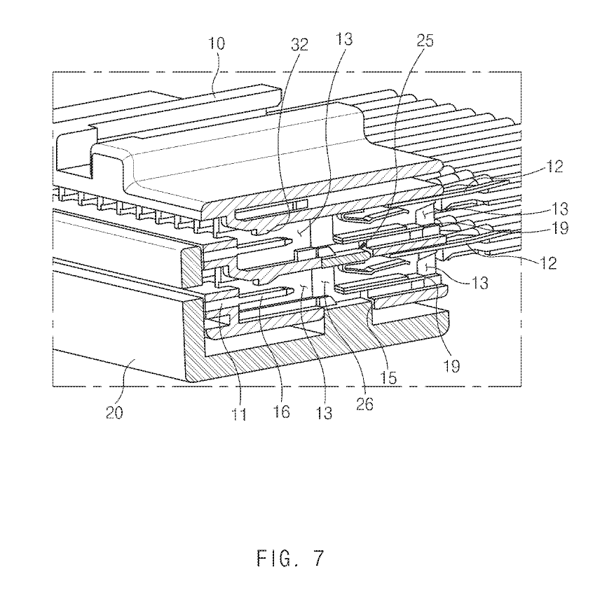

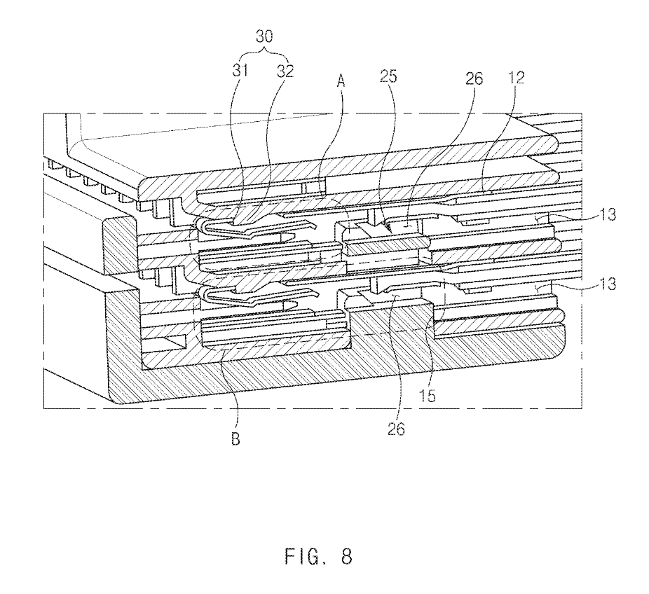

As illustrated in FIGS. 7 and 8, one end of the housing 10 may be coupled to a bus bar 11, and one or more of a plurality of accommodating holes 13, in which one or more of a plurality of terminals 12 are individually accommodated, may be formed in the housing 10.

The bus bar 11 may have a plurality of connection protrusions 16, and the plurality of terminals 12 may be individually connected to the plurality of connection protrusions 16. A connection part 18 may be formed at a front end of the terminal 12, and the connection part 18 may be formed in a structure bent at a predetermined angle to elastically contact with the connection protrusion 16 of the bus bar 11 by elastic force thereof. Accordingly, the terminals 12 and the bus bar 11 may be electrically and firmly, or mechanically, connected.

Insertion openings 15, which may be in communication with the plurality of accommodating holes 13, may be formed in the housing 10, and may be formed in a direction which is perpendicular to the plurality of accommodating holes 13.

The cover 20 may be coupled to an outer surface of the housing 10. Particularly, the cover 20 may be formed in a structure in which the cover 20 surrounds a bottom surface and one or more side surfaces of the housing 10.

A holder 25 may be formed integrally on a bottom surface of the cover 20, and when the cover 20 is coupled to the housing 10, the holder 25 may be insertedly coupled to the insertion openings 15 of the housing 10.

The holder 25 may have a plurality of through openings 26 through which the plurality of terminals 12 individually may pass, or through which each of the plurality of terminals 12 individually may pass. Accordingly, after the holder 25 is insertedly coupled to the insertion openings 15 of the housing 10, the terminals 12 accommodated in the accommodating holes 13 may pass through the through openings 26 of the holder 25, thereby making it possible to form electrical contact points with the connection protrusions 16 of the bus bar 11.

As such, since the holder 25 is insertedly coupled to the insertion openings 15 of the housing 10, the terminals 12 accommodated in the accommodating holes 13 of the housing 10 may be firmly connected to the connection protrusions 16 of the bus bar 11.

According to various exemplary embodiments of the present disclosure, the joint connector may include a locking part 30 for locking the terminals 12 to the accommodating holes 13 of the housing 10.

The locking part 30 may have a locking opening 31 formed in each of the terminals 12, and a locking protrusion 32 protruding from an inner surface of the accommodating hole 13.

By the locking part 30, the locking protrusion 32 of the accommodating hole 13 may be insertedly coupled to the locking opening 31 of the terminal 12 when each of the terminals 12 is accommodated in the accommodating hole 13 of the housing 10. Accordingly, the terminal 12 may be stably locked to the accommodating hole 13 of the housing 10.

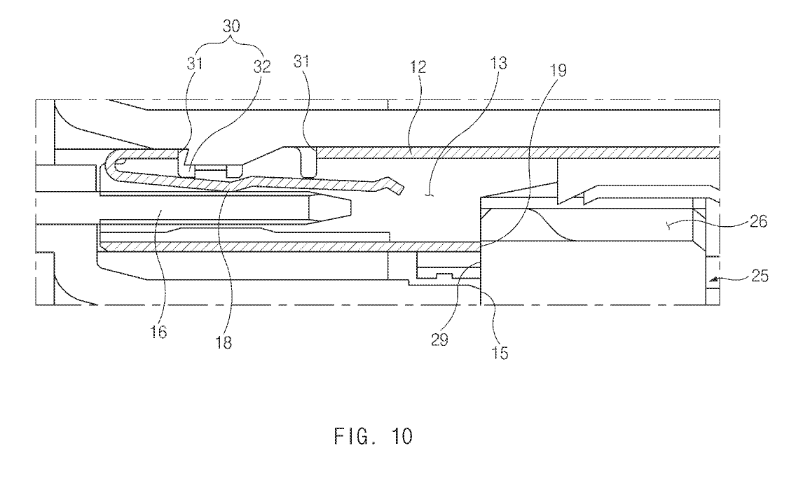

In addition, a stopper surface 29 may be formed on at least one surface of the holder 25, and a stopper 19 which may be caught, or catches, on the stopper surface 29 of the holder 25 may be formed at one side of the terminal 12. Accordingly, after the terminal 12 is locked to the accommodating hole 13 by the locking part 30, since the stopper 19 of the terminal 12 is caught on the stopper surface 29 of the holder 25 as illustrated in FIG. 10, the terminal 12 may be secondarily locked. As a result, an electrical connection between the terminals 12 and the bus bar 11 may be stably implemented.

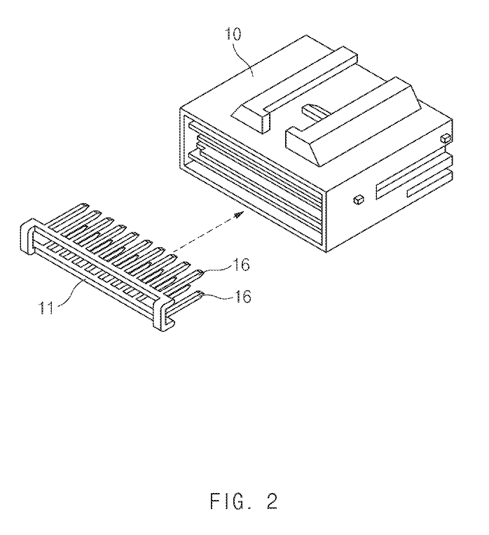

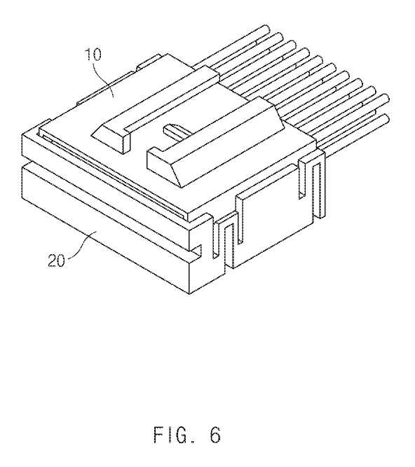

Hereinafter, a process of assembling the joint connector according to an embodiment of the present disclosure having the configuration as described above will be described with reference to FIGS. 2 to 6.

First, as illustrated in FIG. 2, the bus bar 11 may be coupled to one end of the housing 10.

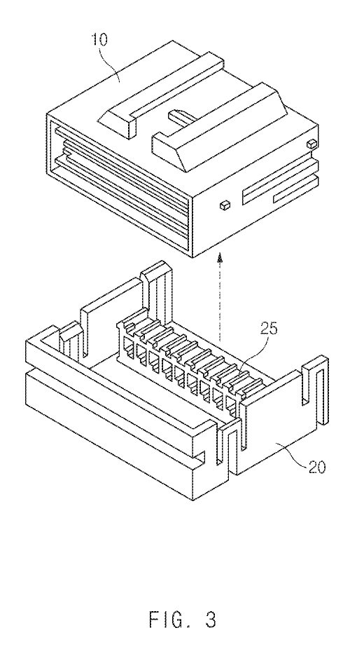

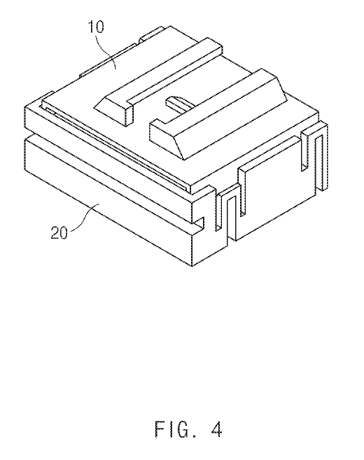

Thereafter, as illustrated in FIG. 3, the cover 20 may be coupled to an outer surface of the housing 10. Accordingly, as illustrated in FIG. 7, the holder 25 of the cover 20 may be insertedly coupled to the insertion openings 15 of the housing 10. Accordingly, as illustrated in FIG. 4, a preliminary assembly product in which the cover 20 is coupled to the outer surface of the housing 10 may be completed.

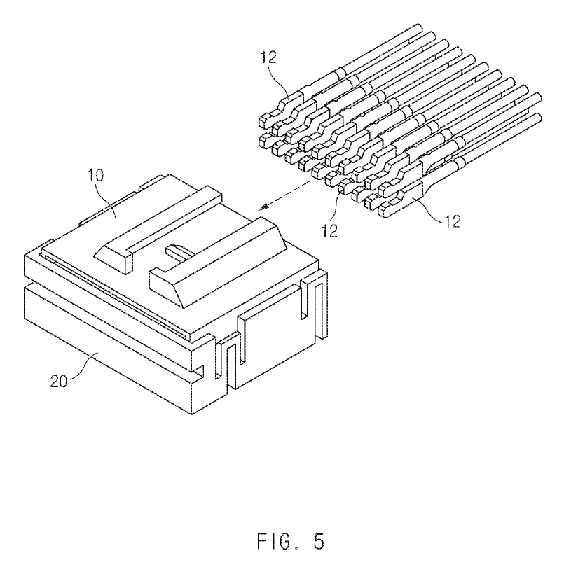

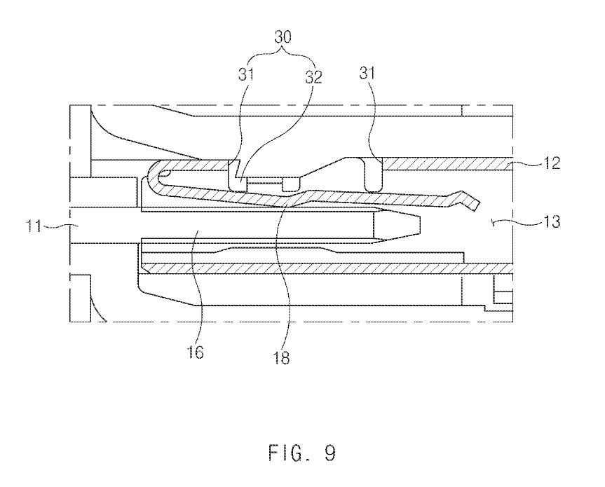

Thereafter, when the plurality of terminals 12 is inserted into the accommodating holes 13 of the housing 10 as illustrated in FIG. 5, the locking protrusions 32 of the accommodating holes 13 may be insertedly coupled to the locking openings 31 of the terminals 12 as illustrated in FIG. 9, and the connection part 18 of the terminals 12 may elastically contact with the connection protrusions 16 of the bus bar 11.

In addition, as illustrated in FIG. 10, the stopper 19 of the terminal 12 may be caught on the stopper surface 29 of the holder 25. Accordingly, the terminals 12 may be firmly locked to the accommodating holes 13 of the housing 10, thereby making it possible to stably implement the electrical connection between the terminals 12 and the bus bar 11.

As described above, according to an exemplary embodiment of the present disclosure, the unit cost for manufacturing the joint connector may be reduced as well as the number of assembly processes may be reduced by minimizing the number of components, and further the electrical connection performance may be stably maintained by firmly locking the terminals.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure as claimed in the following claims.

What is claimed is:

1. A joint connector comprising:
a housing having a bus bar formed therein, having a plurality of accommodating holes in which a plurality of terminals connected to the bus bar are individually accommodated, and having insertion openings in communication with the plurality of accommodating holes; and
a cover coupled to an outer surface of the housing and having a holder insertedly coupled to the insertion openings.

2. The joint connector according to claim 1, wherein the bus bar includes a plurality of connection protrusions,
wherein the plurality of connection protrusions are individually accommodated in the plurality of accommodating holes, and
wherein the terminal is connected to each of the connection protrusions of the bus bar in each of the accommodating holes.

3. The joint connector according to claim 1, wherein a connection part is formed at a front end of the terminal, and
the connection part contacts with a connection protrusion of the bus bar by elastic force.

4. The joint connector according to claim 1, wherein the holder includes a plurality of through openings through which the plurality of terminals individually pass.

5. A joint connector comprising:
a housing having a bus bar coupled to an interior thereof and accommodating a plurality of terminals connected to the bus bar;
a cover coupled to the housing; and
a locking part for locking the terminals to accommodating holes.

6. The joint connector according to claim 5, wherein the locking part includes locking openings formed in the terminals, and locking protrusions protruding from inner surfaces of the accommodating holes to be insertedly coupled to the locking openings.

7. The joint connector according to claim 5, wherein the housing includes a plurality of accommodating holes in which the plurality of terminals are individually accommodated, and insertion openings in communication with the plurality of accommodating holes.

8. The joint connector according to claim 7, wherein the cover has a holder insertedly coupled to the insertion openings of the housing, and the holder has a plurality of through openings through which the plurality of terminals individually pass.

9. The joint connector according to claim 8, wherein the terminal has a stopper which catches on one surface of the holder.
